(19) United States
(12) Patent Application Publication
(10) Pub. No.: US 2010/0108608 A1
(43) Pub. Date: May 6, 2010

(54) CO-SINTERED POLYMER STRUCTURES

(75) Inventor: David Richard Cowieson, Wrexham (GB)

Correspondence Address: SHUMAKER & SIEFFERT, P. A., 1625 RADIO DRIVE, SUITE 300, WOODBURY, MN, 55125, US

(73) Assignee: Porvair Filtration Group Limited, Fareham, Hampshire (GB)

(21) Appl. No.: 12/440,378

(22) PCT Filed: Sep. 4, 2007
(86) PCT No.: PCT/GB2007/003327

§ 371 Date: Nov. 2, 2009

(30) Foreign Application Priority Data
Sep. 8, 2006 (GB) 0617738.0

(51) Int. Cl. B01D 15/08; C08F 110/02

(52) U.S. Cl. 210/660; 521/50; 521/143; 210/510.1; 210/496

(57) ABSTRACT

A co-sintered porous polymer includes at least one molecule specific powder for adsorbing at least one target molecule from a complex liquid mixture when the liquid is passed through the porous co-sintered polymer. The co-sintered polymer can include a sintered porous polyethylene substrate. The or each molecule specific powder can be an immobilising adsorbent powder, for example a molecularly imprinted polymer or a rationally designed polymer.

### BACKGROUND

The present invention relates to co-sintered polymer structures. An example application for the subject matter of the present application is as a product for providing separation processes, for example solid phase extraction, to a method of manufacturing such a product and to the use of such a product.

Solid Phase Extraction (SPE) is widely used to prepare samples for LC-MS (Liquid Chromatography-Mass Spectroscopy) and GC-MS (Gas Chromatography-Mass Spectroscopy) analysis. It is used to remove complex chemical species that might interfere with the analysis and also to change the original solvent to something more compatible with the LC column. Molecularly Imprinted Polymers (MIPs) and Rationally Designed Polymers (RDPs) are polymeric materials that are designed to have very specific adsorption properties often targeting a specific molecular structure or class of such structures. These adsorbent materials are often used in very small amounts to capture trace quantities of analyte from small sample volumes.

This combination of attributes is a challenge for the traditional SPE column based on a loose powder confined between two porous polyolefin frits.

FIG. 1 is a schematic representation of a conventional SPE column 10 in which a molecule specific powder 12 is held between a first sintered polymer frit 14 and a second sintered polymer frit 16. The frits 14 and 16 are used to retain the molecule specific powder in the column, while still allowing for the passage of eluents and other liquids used in an SPE process.

FIG. 2 illustrates a typical structure of a porous polymer of such a sintered polymer frit.

Disadvantages of the type of column illustrated in FIG. 1 include the loose packed structure that offers little resistance to flow and allows liquid channelling (i.e. the flow of liquid forces a channel to form providing an even lower flow resistance and reducing the effective surface area of the molecule specific powder in contact with the liquid. In addition the porous frits used to contain the powder increase the hold up volume of the column. These disadvantages become serious when small analyte volumes and small adsorbent powder weights are used in a column to the point where the separation process can be badly affected and the degree of analyte recovery becomes unacceptable.

The aim of the invention is at least to mitigate the disadvantages of the prior art.

### SUMMARY

An aspect of the invention provides a co-sintered porous polymer comprising a porous polymer substrate and at least one molecule specific powder immobilised therein.

An example of such a co-sintered porous polymer comprising a molecule specific powder provides a mechanism for immobilising the powder(s) to produce a porous microstructure with optimum liquid flow characteristics.

Adjusting the pressure, heat and particle size can be used to alter the porosity of the structure to control the liquid flow rate through it. As a result liquid channels can be prevented from developing in the structure and a resistance to flow can be achieved that is sufficient to allow adsorption and desorption processes to occur as efficiently as possible. An analyte can be exposed to more of the surface area of the adsorbent material and its residence time within the structure can be more effectively controlled.

Another aspect of the invention is a co-sintering process for manufacturing such a co-sintered polymer.

A further aspect of the invention is a method of using such a co-sintered polymer.

### BRIEF DESCRIPTION OF THE DRAWINGS

Embodiments of the present invention will now be described, by way of example only, with reference to the accompanying drawings, in which:

FIG. 1 is a schematic representation of a conventional SPE column;

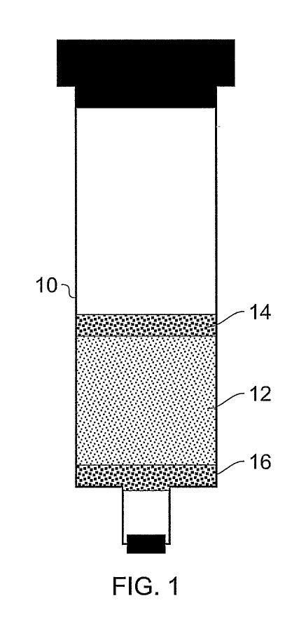

FIG. 2 illustrates a conventional sintered porous polymer;

FIG. 3 is a schematic representation of an SPE column employing frits comprising of a co-sintered polymer according to the present invention;

FIG. 4 illustrates an example of a co-sintered polymer according to an example embodiment of the invention;

FIG. 5 is a table illustrating porosity and flow rates of various co-sintered fits;

FIG. 6 is a table illustrating porosity and flow rates of various further co-sintered frits;

FIG. 7 is a table illustrating LC-MS results for extracts of domoic acid from water;

FIG. 8 is a table illustrating LC-MS results for extracts of domoic acid from sea water;

FIG. 9 is a further table illustrating LC-MS results for extracts of domoic acid from sea water;

FIG. 10 is a further table illustrating LC-MS results for extracts of domoic acid from sea water;

FIG. 11 is a table illustrating LC-MS results for extracts of salbutamol from pig plasma;

FIG. 12 is a further table illustrating LC-MS results for extracts of salbutamol from pig plasma;

FIG. 13 is a flow diagram illustrating a method of preparing a co-sintered porous polymer.

### DESCRIPTION

Example embodiments of the invention will be described in the following, whereby one or more molecule specific powders are immobilised within the structure of a sintered porous polymer, for example polyethylene. Such a co-sintered material can be used in, for example, SPE applications.

A co-sintered porous polymer comprising a polyolefin and the molecule specific powder(s) is used to immobilise the molecule specific powder(s) but allows the passage of eluents and other liquids used.

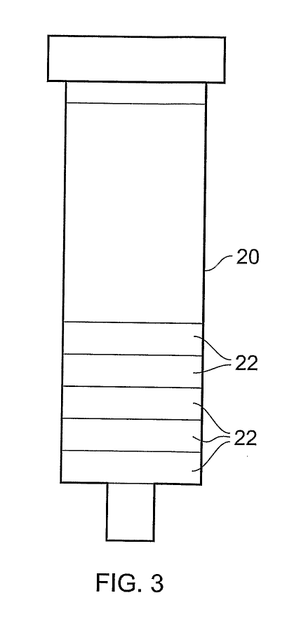

FIG. 3 is a schematic representation of an example of a SPE column 20 including a plurality of fits 22, the frits 22 comprising one or more co-sintered porous polymers that each include at least one molecule specific powder.

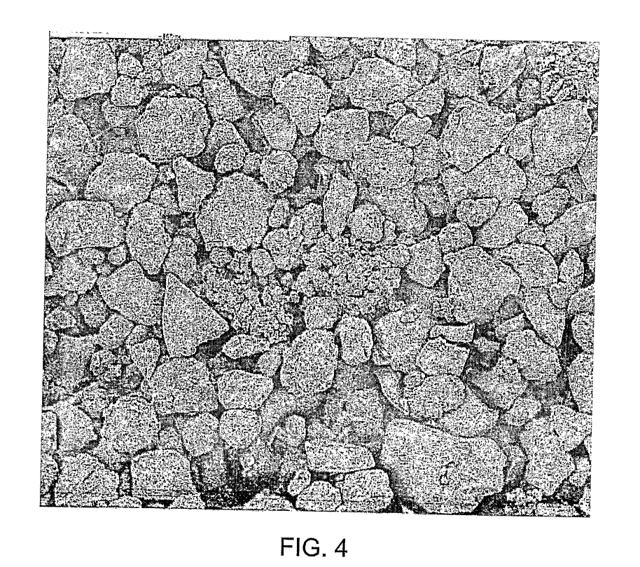

Compared to the use in the prior art of powered molecule specific powders retained in an SPE column between polyethylene fits, immobilising one or more molecule specific powers within a porous structure (e.g., the frits 22 in FIG. 4), can have several advantages. It can help to prevent liquid channelling through an SPE cartridge or column (e.g., the SPE column 20 of FIG. 3). It can remove the need for plain polyethylene frits to contain loose powder (reducing the overall liquid hold up volume of the column). It can help to decrease the number of process steps required during the manufacture of such SPE columns.

FIG. 4 illustrates an example of a co-sintered polymer according to an example embodiment of the invention. FIG. 4 illustrates an example of a microstructure of a porous polyethylene co-sinter containing a polymerised form of trifloromethacrylic acid (TFMAA) powder as a molecule specific powder.

In the following the effect of immobilising adsorbent molecule specific powders in a porous polymer structure, for example a porous polyethylene structures, in an SPE process will explained with respect to examples.

A first example uses TFMAA, which is a “rationally designed polymer (RDP)” developed for specific adsorption of domoic acid. An example of a rationally designed polymer can be developed from, for example, a computer model of the target molecule.

A second example uses a “molecularly imprinted polymer” (MIP) imprinted for salbutamol (SB). A MIP is a polymer imprinted with a template molecule, which forms a target molecule (e.g., a drug). A MIP can be created by forming a polymer around the target molecules and then removing the molecule leaving the imprint of the molecule in the polymer, which can then be used to target that molecule.

Both polymers were studied in 1 ml SPE cartridges as co-sintered frits and as loose powders held between plain PE frits.

Ultraviolet (UV) spectroscopy and LC-MS were used to detect the presence of analyte in the eluents and estimate recovery.

Various particle sizes distributions of the MIP powders were studied. In particular, examples of the following particle size distributions (sieve fractions) were investigated:
63 μm-106 μm
106 μm-212 μm
212 μm-300 μm

The porosity and flow rate of co-sintered MIP frits were investigated. In general co-sintered frits formed from the smallest particle sieve fractions of the molecule specific powder packed more tightly with the PE powder and displayed the lowest void volume and lowest eluent flow rates compared to larger particle size ranges under similar test conditions. Void volumes for the co-sintered frits were in the range 38%-50%. Where comparisons were possible, columns with co-sinters had lower eluent flow rates than those with loose powders.

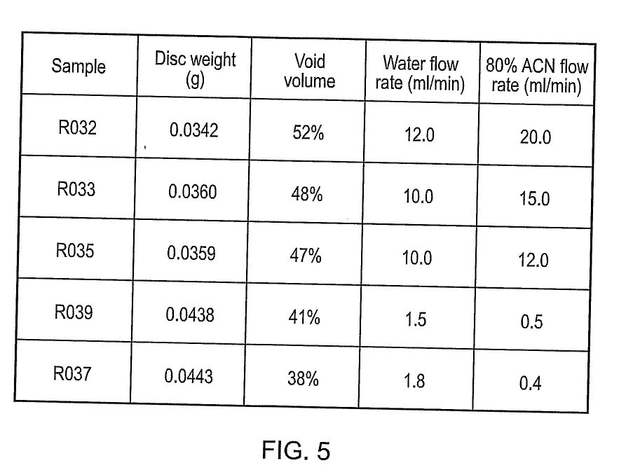

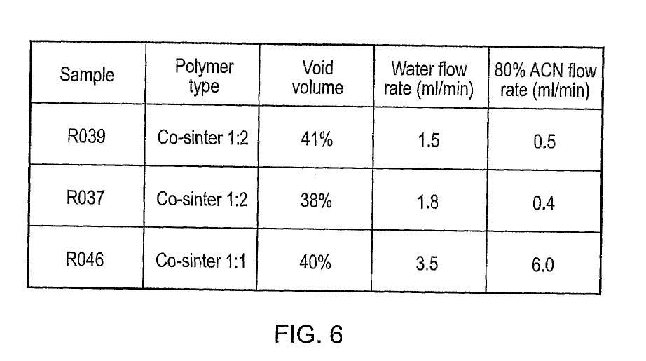

FIGS. 5 and 6 are tables showing porosity and flow rates of various co-sintered frits in 1 ml SPE columns. All of the columns in FIGS. 5 and 6 are based on a 63-106 μm TFMAA powder. It can be seen that eluent flow rates were higher in co-sinters with greater porosity. Organic eluents such as acetonitrile (ACN) with lower viscosities than water have higher flow rates than water. This trend breaks down when the porosity drops to around 40% or below. The flow rates for water and 80% ACN are dramatically reduced and the latter is significantly slower probably because the TFMAA powder is swelling in the ACN. The very low flow rates caused by this swelling effect were considered a problem for the low porosity co-sinters. It is possible that the TFMAA would swell less if the ratio of monomer to solvent was reduced from 1:2 to 1:1 in the polymerisation mixture. When the 1:1 polymer was incorporated in the co-sinter flow rates for comparable columns improved for both water and 80% ACN and the ACN retained its higher flow rate compared to water.

Surprisingly, comparing surface area before and after co-sintering using nitrogen adsorption surface area analysis the co-sintering does not lead to a significant loss of adsorbent surface activity. One concern with the co-sintering process was that there might be a significant loss of adsorbent surface activity caused by masking with the polyethylene (PE) powder during the co-sintering process. A 40% MIP/60% PE powder was made up and measured using nitrogen adsorption surface area analysis before and after co-sintering. The results are shown below:
Surface area of loose mixed powder=99.6 sq.m/g
Surface area co-sintered compact=90.0 sq.m/g

It was assumed that the polyethylene powder will have a negligible effect on the overall surface area of the mixture either before or after sintering. The 10% apparent reduction in surface area is within the instrumental error of the analyser and is not considered to be significant.

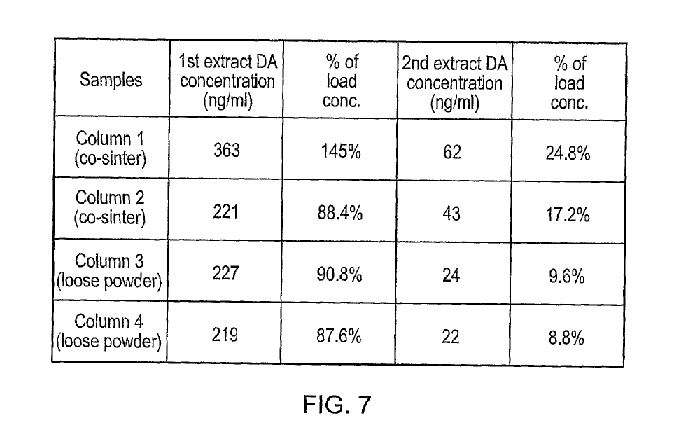

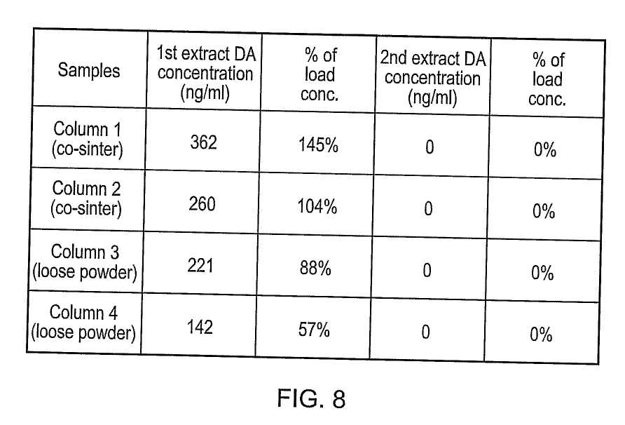

An analysis of LC-MS for domoic acid in water was conducted. Early work using 50 μl of a 250 ng/ml standard solution to challenge columns containing 16 mg of TFMAA powder gave inconsistent results. When the powder content in the column was increased to 64 mg and 300 μl of the same challenge solution was used high levels of recovery were achieved in both water and sea water. The results of this analysis are shown in FIGS. 7 and 8. The columns contained 64 mg of TFMAA powder and were challenged with 300μ of a 250 ng/ml solution of domoic acid in water. The extract was dried and dissolved back into 300 μl of water.

With reference to FIG. 7, the following is noted for the LC-MS for domoic acid in water. In order to work with small sample volumes it was necessary to understand the reasons why the smaller columns produced inconsistent results. Six new columns were made up containing 16 mg, 32 mg and 64 mg of co-sintered TFMAA powder and the same quantities of loose powder. These were challenged with proportional volumes of the standard DA solution and this was done at fast and slow flow rates.

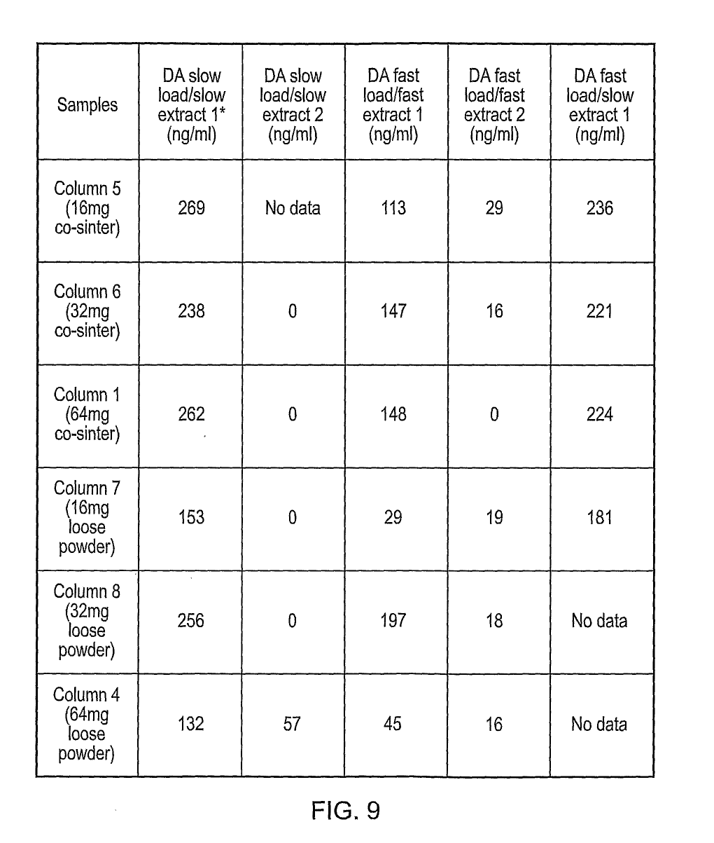

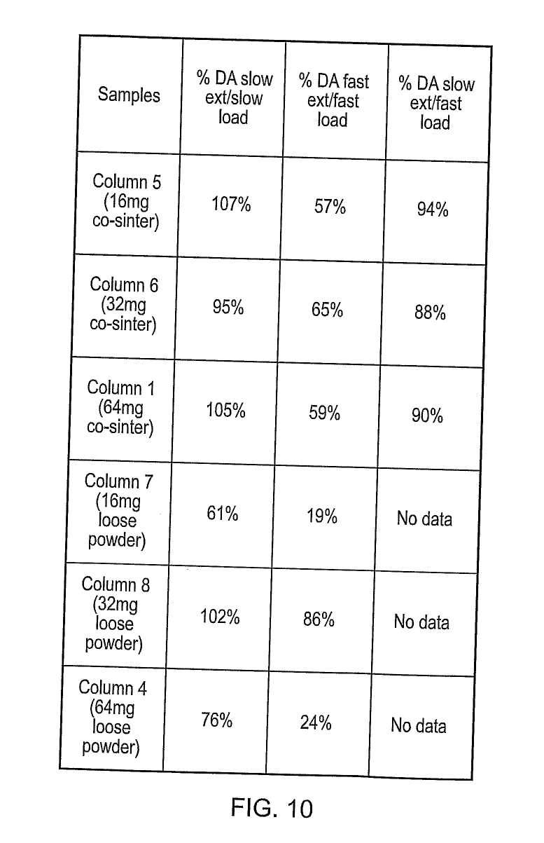

FIGS. 9 and 10 illustrate further results for LC-MS for domoic acid in sea water. In FIGS. 9 and 10, slow load or extract indicates that the eluent typically took more than 20 seconds to flow through the column, and fast load or extract indicates that the eluent typically took less than 5 seconds to flow through the column.

The results for domoic acid using co-sintered fits demonstrate the following. High levels of extraction of domoic acid from DI water and sea water was successfully accomplished with both loose powder and co-sinters. Control of the eluent flow rate through the column had a significant effect on the ability to achieve high recovery. In general a flow rate through the column of more than 20 seconds is necessary to ensure high recovery. The increased resistance to flow in the co-sintered columns generally aided the loading and extraction process. It was possible to successfully load and extract from 75 μl samples, but recoveries were generally better for the co-sintered columns.

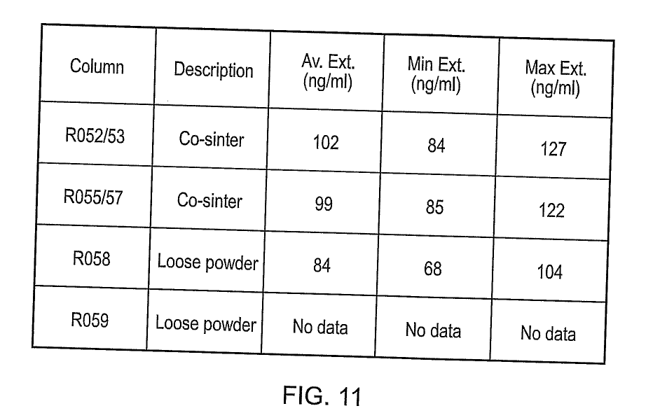

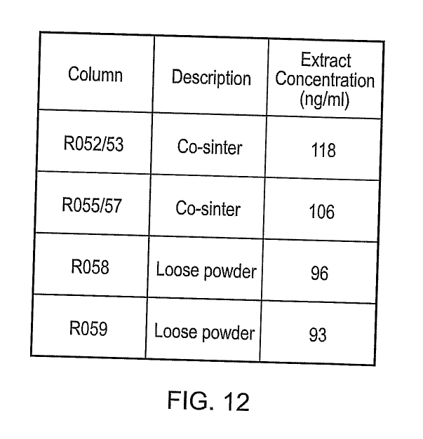

FIGS. 11 and 12 illustrate results for salbutamol using co-sintered MIP frits. FIGS. 11 and 12 set out an LC-MS analysis of eluates from 100 ng/ml challenges of salbutamol in plasma. For the results illustrated in FIGS. 11 and 12, the columns were loaded with 1 ml of a 100 ng/ml salbutamol solution in pig plasma (pig blood with the blood cells removed], then extracted with 1 ml of a 0.125 mole NH4OH in MeOH which was then dried and made back up with 1 ml of water. The analysis was carried out with fresh standards prepared in water in FIG. 11 and with fresh standards prepared in MeOH in FIG. 12.

The salbutamol results using co-sintered MIP fits demonstrated the following:
Extraction of 100 ng/ml salbutamol from DI water and blood plasma was successfully accomplished with both loose powder and co-sintered frit columns.
No salbutamol was present in the spent challenge solution (in water) or the washes.
The co-sintered fit columns extracted significantly higher amounts of salbutamol than the loose powder columns with recoveries greater than 95% from blood plasma.

From the above results it is concluded that co-sintering MIP powders into sintered porous-polymers produced composite structures that:
retained their specific adsorption properties;
provided better flow control within the column;
produced better recoveries than loose powders; and
worked more effectively with smaller quantities of analyte.

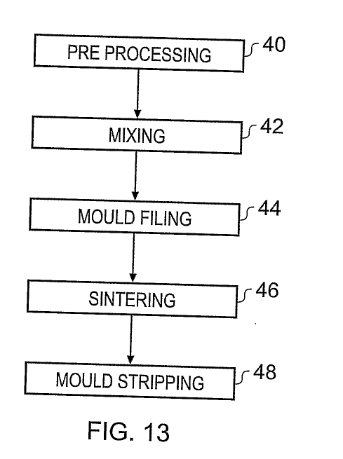

FIG. 13 is a flow diagram illustrating an example of a process for forming co-sintered frits comprising one or more molecule specific powders.

In this example the co-sintered porous polymer material is prepared by sintering thermoplastic granules, powder or pellets forming a substrate with the molecule specific powder, which is typically also based on a polymer.

The ability of a thermoplastic polymer to be sintered can be determined from its melt viscosity the higher the melt viscosity the easier it becomes to form a sintered porous structure. Suitable thermoplastics that can be used to provide the porous polymer substrate include, but are not limited to, polyolefins, nylons, polycarbonates, polyether sulfones, polystyrene and mixtures thereof. A preferred thermoplastic is a polyolefin. Examples of suitable polyolefins include, but are not limited to: ethylene vinyl acetate; ethylene methyl acrylate; polyethylenes; polypropylenes; ethylene-propylene rubbers; ethylene-propylenediene rubbers and mixtures and derivatives thereof. A preferred polyolefin is polyethylene. Examples of suitable polyethylenes include, but are not limited to, low density polyethylene, linear low density polyethylene, high density polyethylene, ultra-high molecular weight polyethylene, and derivatives thereof.

A range of particle sizes for polyethylene could be in the range of 10 μm to 800 μm, for example in the range of 30 μm to 500 μm, or for example in the range of 100 μm to 300 μm. A fine pore structure might be made for a range of 10 μm to 100 μm, a medium pore structure from 100 μm to 300 μm, and a coarse structure from 300 μm to 800 μm. In one example, a coarse structure, i.e. 300 μm to 800 μm can be used.

The steps of the example method of FIG. 13 will now be described.

Pre-Processing 40

Polymer particles are made using cryogenic or ambiently grinding a suitable polymer material and then screening the result to ensure a proper particle size distribution for the substrate.

The or each molecule specific power is generated cryogenic or ambiently grinding a suitable molecule specific powder and then screening to ensure a proper particle size distribution.

Mixing 42

The particles for the polymer substrate are then mixed with the molecule specific powder(s).

Mould Filling 44

The resultant mixture is then placed in a mould, or multiple moulds. Moulds can be made of carbon steel, stainless steel, brass, or aluminium, and may have a one or more cavities. Mould filling is preferably assisted by using commercial powder handling and vibratory equipment.

Sintering 46

Thermal processing is carried out by introducing heat to the mould, using any appropriate controllable heating means. Electrical resistance heating, electrical induction heating, or steam heat may be used. The applied heat is controlled as appropriate to allow softening of the polymer particles and allow inter-particle binding to occur. Processing of parts with consistent porosity, strength, and flow characteristics is dependent on carefully considered application of commercial process control equipment. Control of the temperature cycle must allow consistent part manufacture such that there are no problems with under-processing which leads to weak, unsintered parts, or overprocessing, leading to glazed, non-porous parts.

Another method is available where material is laid down on a suitable belt and passed through a sintering oven to make continuous sheet which can be later fabricated into required shapes.

Mould Stripping 48

The product is then removed from the mould. The product can be in the form of a fit comprising or formed from the co-sintered polymer.

The product can then be used in a solid phase extraction apparatus.

The co-sintered porous polymer frit(s) can, for example, be included in a column for use in an SPE process using, for example, a vacuum manifold. Alternatively, one or more frits of the co-sintered polymer can be introduced into the column of an SPE apparatus.

The SPE apparatus can then be used to adsorbing a molecule for which a molecule specific powder of the co-sintered polymer is designed by passing a fluid, e.g., a liquid, containing the molecule through the SPE column.

As indicated above, one or more frits of the co-sintered polymer can be introduced into the column of an SPE apparatus. The number of frits of the co-sintered polymer that are used can be chosen for any particular application to achieve a desired adsorption volume. Increasing the number of fits can increase the adsorption volume.

The co-sintered polymer may include a single molecule specific powder. A single molecule specific power can be suitable in many applications, for example to adsorb a single type of molecule. However, in other applications, it may be desirable to use two or more molecule specific powders.

For example, different molecule specific powders may be designed to adsorb a single molecule. An example of this is where each of a plurality of different molecules specific powders, that is two or more molecule specific powders, target different parts of a molecule. For example, different MIPs or RDPs may target different parts of a molecule. Alternatively, or in addition, a combination of one or more RDPs and MIPs could be used to target the same molecule or different parts of the same molecule. Both approaches can potentially be used to increase an adsorption efficiency in appropriate applications.

Also, in some applications it may be desirable to adsorb a plurality of different molecules (i.e. two or more molecules). For example different MIPs may be used to target different contaminants.

Using multiple molecule specific powders can be advantageous where it is desired to adsorb the multiple molecules in a single pass, to avoid having to pass the fluid a multiple of times through an SPE apparatus.

One specific example of this might be where it is desired to adsorb toxins associate with shellfish poisoning. It is described above that a molecule specific powder can be used to target domoic acid. Domoic acid is a toxin associated with cases of amnesic shellfish poisoning (ASP). Another example of shellfish poisoning, diarrhetic shellfish poisoning (DSP), is associated with another toxin, okadaic acid. Other forms of shellfish poisoning are associated with other forms of toxin. Accordingly, in an application where it is desired to adsorb toxins associated with different forms of shellfish poisoning, it may therefore be desirable to seek to adsorb multiple such toxins in a single pass.

It will be appreciated that the example of toxins associated with shellfish poisoning is merely one instance of an example application for adsorbing a plurality of different molecules in a single pass.

Adsorbing a plurality of different molecules in a single pass can, for example, be achieved by incorporating multiple molecule specific powders in a co-sintered polymer of a single frit, or in respective co-sintered polymers of respective frits, or in respective co-sintered polymers of a laminated frit, as will be described in more detail in the following.

Due to the manner in which the co-sintered polymers are manufactured, that is by co-sintering the porous polymer substrate and the molecule specific powder(s), a co-sintered polymer can readily be manufactured where the porous polymer substrate is co-sintered with multiple different molecule specific powders. In this manner, a co-sintered polymer can be manufactured that includes a combination of different molecule specific powders.

Also, a number of different layers could be laminated together to form a composite frit, wherein each layer includes a co-sintered polymer comprising a porous polymer substrate with one or more molecule specific powders immobilised therein. The lamination of multiple layers could be effected as part of the manufacturing process by bonding multiple layers together using heat and/or a bonding agent.

Also, in any given application, different combinations of one or more frits may be used.

For example, as described above, multiple frits of the same co-sintered polymer may be used to achieve a given adsorption capacity.

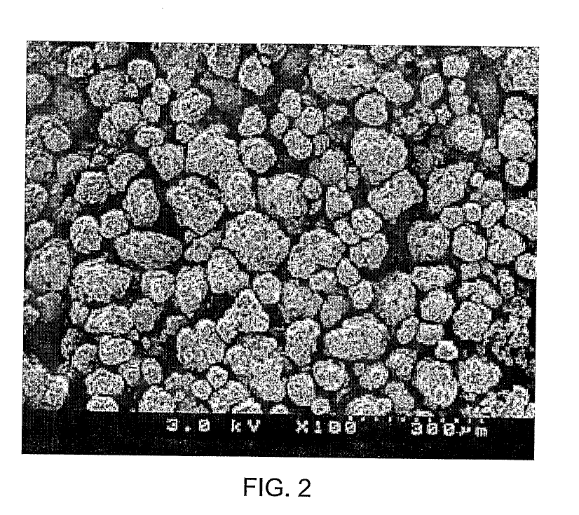

In another example where multiple fits are used, the porous polymer for one or more of frits may be different from the porous polymer or one of more of the other fits. In this manner, any combination of adsorption capacities and characteristics for an SPE apparatus may be designed in a very flexible manner. Merely by way of example, in FIG. 2, one or more or each of the fits 22 may comprise a different co-sintered polymer from one or more or each of the other fits 22.

Examples of possible combinations of co-sintered polymers for respective frits can include:
a co-sintered porous polymer comprising a porous polymer substrate and a first molecule specific powder immobilised therein, the first molecule specific powder being for adsorption of a first molecule;
a co-sintered porous polymer comprising a porous polymer substrate and a second molecule specific powder immobilised therein, the second molecule specific powder being for adsorption of the first molecule;
a co-sintered porous polymer comprising a porous polymer substrate and a third molecule specific powder immobilised therein, the third molecule specific powder being for adsorption of a second molecule;
a co-sintered porous polymer comprising a porous polymer substrate and a plurality of molecule specific powders immobilised therein, each molecule specific powder being for adsorption of the same molecule;
a co-sintered porous polymer comprising a porous polymer substrate and a plurality of molecule specific powders immobilised therein, each molecule specific powder being for adsorption of a different molecule;
a co-sintered porous polymer comprising a porous polymer substrate and a plurality of molecule specific powders immobilised therein, a plurality of the molecule specific powders being for adsorption of one molecule and at least one other molecule specific powder being for adsorption of another molecule.

There has been described a co-sintered porous polymer that includes a polymer substrate and at least one molecule specific powder for adsorbing at least one target molecule from a complex liquid mixture when the liquid is passed through the porous co-sintered polymer. The co-sintered polymer can include, for example, a sintered porous polyethylene substrate. The or each molecule specific powder can be an immobilising adsorbent powder, for example a molecularly imprinted polymer or a rationally designed polymer.

Through a co-sintering process the or each molecule specific powder can be immobilised to produce a porous microstructure with optimum liquid flow characteristics. A combination of pressure, heat and particle size can be used to alter the porosity of the structure to control the liquid flow rate through it. The effect of this can be to prevent liquid channels developing in the structure and to create a resistance to flow sufficient to allow the adsorption/desorption processes to occur as efficiently as possible. The analyte can be exposed to more of the surface area of the adsorbent material and its residence time within the structure can be more effectively controlled.

A sintering process can be provided that encapsulates and immobilises specific adsorbent powders such as MIPs that produces a microstructure that improves the SPE process.

A sintering process can be provided that encapsulates and immobilises specific adsorbent powders such as MIPs that produces a microstructure such that the adsorbent can be used more effectively in SPE processes where the sample volumes are very small, typically less than 100 μl more specifically less than 50 μl.

A sintering process can be provided that encapsulates and immobilises specific adsorbent powders within a microstructure that prevents liquid channelling.

A sintering process can be provided that encapsulates and immobilises specific adsorbent powders where the porosity (void volume) of the microstructure is controlled to increase the liquid flow resistance. The porosity can typically be set within the range 35% to 55% and more widely within the range 30% to 65%.

Many variations may be made to the examples, described above whilst still falling within the scope of the invention.

1. A co-sintered porous polymer comprising a porous polymer substrate and a molecule specific powder immobilised therein.

2. The co-sintered porous polymer of claim 1 comprising the porous polymer substrate and a plurality of molecule specific powders immobilised therein.

3. The co-sintered polymer of claim 1, wherein the porous polymer substrate comprises polyethylene.

4. The co-sintered polymer of, claim 1, wherein a said molecule specific powder has been formulated with specific adsorbent properties.

5. The co-sintered polymer of claim 1, wherein a said molecule specific powder comprises molecularly imprinted polymers.

6. The co-sintered polymer of claim 5, wherein said molecule specific powder comprises ground molecularly imprinted polymers.

7. The co-sintered polymer of claim 1, wherein a said molecule specific powder comprises rationally designed polymers.

8. The co-sintered polymer of claim 7, wherein said molecule specific powder comprises ground rationally designed polymers.

9. The co-sintered polymer of claim 1, having a particle size in the range of 30 μm to 500 μm.

10. A frit comprising the co-sintered porous polymer of claim 1.

11. A solid phase extraction apparatus comprising the co-sintered porous polymer of claim 1.

12. The solid phase extraction apparatus of claim 11, comprising a cartridge comprising the co-sintered porous polymer of claim 1.

13. The solid phase extraction apparatus of claim 11, comprising a column comprising the co-sintered porous polymer of claim 1.

14. The solid phase extraction apparatus of claim 11, comprising at least one frit according to claim 10.

15. The solid phase extraction apparatus of claim 11, comprising a plurality of frits according to claim 10, wherein at least one frit comprises a co-sintered porous polymer that is different from the co-sintered polymer of at least one other frit.

16. A method of adsorbing at least one specific molecule, comprising passing a fluid containing the module through a solid phase extraction apparatus of claim 11.

17. A method of manufacturing a co-sintered polymer of claim 1 comprising mixing a polymer for forming a substrate and a molecule specific powder and applying a sintering process to the mixture.

18. The method of claim 17, comprising mixing a polymer for forming a substrate and a plurality of molecule specific powders and applying a sintering process to the mixture.

19. The method of claim 17, wherein the sintering process encapsulates and immobilises the molecule specific powder.
